(19) United States
(12) Patent Application Publication
(10) Pub. No.: US 2024/0122411 A1
(43) Pub. Date: Apr. 18, 2024

(54) BLENDER WITH ISOLATED SOUND ENCLOSURE

(71) Applicant: Sunbeam Products, Inc., Atlanta, GA (US)

(72) Inventors: Enrique Plazarte, Fort Lauderdale, FL (US); Justin McIntire, Wellington, FL (US)

(21) Appl. No.: 18/546,962

(22) PCT Filed: Feb. 18, 2022
(86) PCT No.: PCT/US22/17039

§ 371 Date: Aug. 17, 2023

Related U.S. Application Data
(60) Provisional application No. 63/150,977, filed on Feb. 18, 2021.

(51) Int. Cl. A47J 43/08; A47J 43/046; G10K 11/162

(52) U.S. Cl. CPC A47J 43/085; A47J 43/046; G10K 11/162

(57) ABSTRACT

A blender system is provided that includes a motorized base and a mixing assembly attached thereto in which materials to be blended may be contained and blended. The motorized base includes several mechanisms for reducing noise emitted by the motor that powers the blender blades. The mechanisms may include elastic isolators in communication with components within the blender system, stiff plates positioned to absorb vibrations and noise emitted by the motor, and a sound cover that can be placed around the mixing assembly.

### CROSS-REFERENCE TO RELATED APPLICATIONS

This application claims priority to U.S. Provisional Patent Application Ser. No. 63/150,977, filed on Feb. 18, 2021, entitled “BLENDER WITH ISOLATED SOUND ENCLOSURE,” currently pending, the entire disclosure of which is incorporated herein by reference.

### BACKGROUND OF THE INVENTION

Blending appliances, or blenders, for preparing blended foods and beverages are known in the art. Typically, blenders include a motorized base, a mixing container, one or more blades, and a lid. Because the motorized base requires a great deal of power to operate, and because its operation generates a lot of turbulence, a typical blender can generate a lot of noise and vibration. The vibration can cause other various components of a typical blender to also vibrate, rattle, or otherwise produce additional noise. Noisy blenders can wake up sleeping children or adults and irritate neighbors. They also can make it difficult for operators to hear others talk, televisions, or other audio sources.

### SUMMARY OF THE INVENTION

The blender subject of the current application reduces vibration and sound at the source of the vibration and sound. It does so by coupling the electric motor, including a motor shaft coupled to the electric motor, and the at least one blade, including a blade shaft coupled to the at least one blade, to each other in a way that limits parallel, angular, and general misalignment. This preferably isolates the electric motor from an external housing of the motorized base and encloses the electric motor and the at least one blade within the external housing and a sound cover.

In certain embodiments, the blender may include a locking mechanism, which may comprise a semi-threaded locking feature. When coupling the electric motor and the at least one blade to each other, including via the locking mechanism, a self-centering coupling can be operably coupled to the at least one blade or a blade sub-assembly, and the self-centering coupling can transmit torque from the electric motor to the at least one blade. The self-centering coupling can comprise a spline (including an extended or elongated spline or taper), a long-taper coupling, or any other suitable coupling. In this manner, the motor shaft and blade shaft can have minimal, or little, parallel, angular, and general misalignment, which can have the effect of reducing misalignment.

The blender may reduce vibration by using one or more isolators that isolate the electric motor and the blade (or blades) from the blender's base. Remaining vibration may be transmitted to the kitchen countertop, which has a large mass able to absorb excess vibrations and reduces vibration transmissibility. The blender also may include one or more stiff plates that absorb high frequency vibration produced by the blending agitation of the blender.

Acoustic foam may also be provided (e.g., with the motorized base) that dampens and/or absorbs reverberating sound within the housing of the motorized base produced by the electric motor.

A fan, in particular a low-noise fan (e.g., a fan that does not produce a noise exceeding 67 dBA, or a fan that is 3 dB quieter than the target sound of the blender), can also be provided as part of the blender's ventilation system to help cool the electric motor. In one embodiment, the airflow path created by the fan and the ventilation system can be torturous or otherwise arranged such that there is no direct line of sight between the electric motor or fan and the outside of the blender. Further, the torturous airflow path may help muffle the sound produced by the electric motor.

The blender preferably includes a sound cover that may be placed over the blending container to absorb some of the noise that comes from within the blending container when the electric motor is driving the (blade or blades) to blend the contents of the blending container. Such action may produce sound from the surface of the blending container due to liquid cavitation, ice crushing, and the like. The sound cover can comprise dense, thick, and/or stiff material, including plastic or other suitable materials, or any combination thereof. In any event, the material should have muffling or suppressing qualities to reduce the sound produced by the blending container or other components of the blender during use.

The sound cover is preferably solid without any openings (or few, small openings) in order to reduce, or prevent, any sound from escaping from the sound cover. When operably coupled to the housing of the motorized base, the housing and the sound cover may be decoupled or otherwise isolated from the electric motor or other sources of vibration of the blender. Thus the amount of vibrations transmitted from the electric motor to the housing or the sound cover may be reduced. Further, the housing and the sound cover can be separated from each other by a sealing sub-assembly to block sound and reduce vibration and resonance that might be transferred between the housing and the sound cover.

### BRIEF DESCRIPTION OF THE DRAWINGS

For a better understanding of the present invention, reference may be made to the following accompanying drawings.

FIG. 1 is a perspective view of a blender according to the teachings of the current invention.

FIG. 2 is an exploded perspective view of a motorized base of a blender according to the teachings of the current invention.

FIG. 3 is an exploded perspective view of a mixing assembly of a blender according to the teachings of the current invention.

FIG. 4 is a perspective view of a blending container coupled with an electric motor of a blender according to the teachings of the current invention.

FIG. 5 is a cross-sectional perspective view of the blending container coupled with the electric motor of the blender of FIG. 4.

FIG. 6 is a schematic representation of a blender according to the teachings of the current invention.

FIG. 7 is a perspective view of a blender without a housing or a sound cover according to the teachings of the current invention.

FIG. 8 is a cross-sectional perspective view of the blender without a housing or a sound cover of FIG. 7.

FIG. 9 is a cross-sectional perspective view of a blender according to the teachings of the current invention.

FIG. 10 is a cross-sectional elevation view of a blender according to the teachings of the current invention.

FIG. 11 is a detail view of a portion of a blender according to the teachings of the current invention.

FIG. 12 is a perspective view of a blender without a housing according to the teachings of the current invention.

FIG. 13 is an elevation view of the blender without a housing of FIG. 12.

FIG. 14 is a perspective view of a blender without a housing or a sound cover according to the teachings of the current invention.

FIG. 15 is a cross-sectional elevation view of a blender according to the teachings of the current invention.

FIG. 16 is a cross-sectional elevation view of the blender FIG. 15 with representative arrow diagrams of an airflow path.

FIG. 17 is a cross-sectional elevation view of a blender according to the teachings of the current invention with representative arrow diagrams of an airflow path.

FIG. 18 is a partial cross-sectional perspective view of a blender according to the teachings of the current invention.

FIG. 19 is a cross-sectional elevation view of a blender according to the teachings of the current invention with representative arrow diagrams of an airflow path.

FIG. 20 is a cross-sectional elevation view of a blender according to the teachings of the current invention with representative arrow diagrams of an airflow path.

FIG. 21 is a partial cross-sectional perspective view of a blender according to the teachings of the current invention with representative arrow diagrams of an airflow path.

FIG. 22 is a perspective view of a blender according to the teachings of the current invention.

FIG. 23 is a cross-sectional perspective view of the blender of FIG. 22.

### DETAILED DESCRIPTION OF THE INVENTION

The invention will now be described with reference to the drawing figures, in which like reference numerals refer to like parts throughout. For purposes of clarity in illustrating the characteristics of the present invention, proportional relationships of the elements have not necessarily been maintained in the drawing figures. It will be understood that any dimensions included in herein are simply provided as examples and dimensions other than those provided therein are also within the scope of the invention.

The following detailed description of the invention references specific embodiments in which the invention can be practiced. The embodiments are intended to describe aspects of the invention in sufficient detail to enable those skilled in the art to practice the invention. Other embodiments can be utilized and changes can be made without departing from the scope of the present invention.

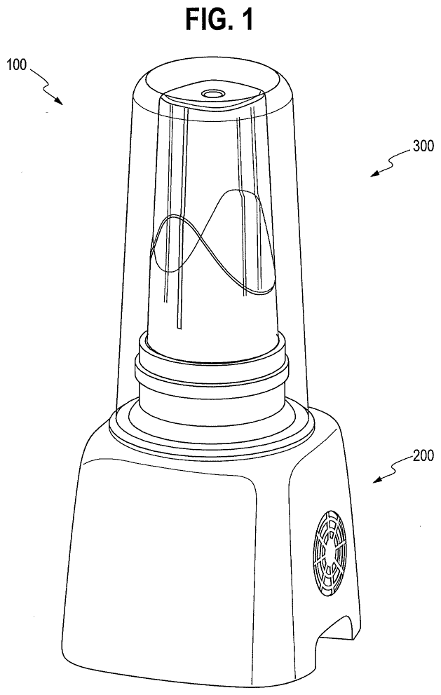

Turning first to FIG. 1, a blender 100 subject of the current application may generally comprise a motorized base 200 and a mixing assembly 300 in which foodstuffs may be blended.

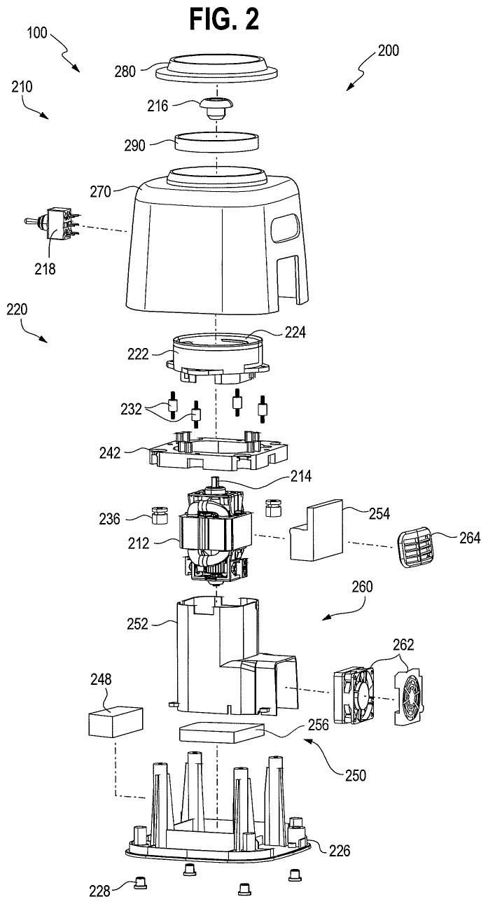

FIG. 2 further illustrates the motorized base 200. The motorized base 200 can generally comprise a motor assembly 210, a motor mount assembly 220, a noise dampening system 250, a ventilation system 260, and a housing 270. The motorized base 200 can further include a sealing sub-assembly 280 and a drain 290.

The motor assembly 210 preferably includes an electric motor 212, a motor shaft 214, a self-centering coupling 216, and a power switch 218. It will be understood that any type of mechanical or electronic control could be used in place of power switch 218, as desired. In one embodiment, the electric motor 212 can be a universal motor. However, it will be understood that the electric motor 212 can be any suitable motor. The self-centering coupling 216 can be a spline coupling, a long-taper coupling, or any other suitable coupling.

The motor mount assembly 220 generally may comprise a motor mount 222 (to which the motor 216 is couplable) and a base 226. In one embodiment, the motor mount 222 can be adapted to attach to or operably couple with the electric motor 212, and the electric motor 212 can be attached or operably coupled to the motor mount assembly 220 via the motor mount 222. The motor mount 222 may further be adapted to support the electric motor 212 independently from any other structural element of the blender 100 and the motorized base 200. In another embodiment, the motor mount 222 can comprise a locking mechanism 224 to operably couple with the mixing assembly 300. The base 226 may include feet 228 to support it and lift it upwardly from a surface on which it sits. In one embodiment, the base 226 can be heavy or comprise a significant amount of mass to stabilize it.

The motor mount assembly 220 preferably includes one or more isolators and one or more stiff plates. The isolators preferably isolate and position certain components away from one another, as described below. The isolators can include any of a plurality of top isolators 232, a plurality of intermediate isolators (not illustrated), a plurality of bottom isolators 236, and/or a plurality of feet isolators (not illustrated). The isolators can be adapted to create a generally self-supporting structure. In one embodiment, any one or more of the isolators can generally comprise elastic or dampening materials sufficient to maintain the necessary structural integrity and also reduce or prevent vibrations produced by the electric motor 212 from transferring to other components of the motorized base. The elastic or dampening material may have a Shore A scale of between about 40 A and 90 A. In another embodiment, any one or more isolators can generally define cylindrical shapes. In yet another embodiment, any one or more isolators can generally define a rectangular prism sheet, which can be die cut from a suitable material, or a molded shape, including a molded cylindrical shape or a molded hollow rectangular prism shape.

The stiff plates preferably dampen, reduce, and/or prevent vibrations in certain components. The stiff plates (which may be alternatively referred to as heavy plates), can include a top stiff plate 242, an intermediate stiff plate (not illustrated), and a bottom stiff plate 246. In one embodiment, any one or more of the stiff plates can be heavy or comprise a significant amount of mass. The stiffness could be similar to that of steel, with a Young's modulus/density of about 25, with a similar weight. However, depending on the geometry of an injection molded plastic part, a stiffness of a material such as Nylon (about 2.6) could also be sufficient, though potentially lighter in weight.

The isolators can be adapted to couple with the stiff plates to create a generally self-supporting structure. For example, in one embodiment, four isolators can be used to support at least one of the stiff plates, including by generally creating legs that connect the at least one of the stiff plates to the base 226 of the motor mount assembly 220, another one of the stiff plates, or a suitable surface for support the structure. However, it will be understood that any number of the isolators or groupings of isolators (e.g., one, two, three, four, five, and so on) can be used to support any number of the stiff plates in any combination, orientation, or attachment means, whether presently known or later developed.

In one embodiment, a plurality of top isolators 232 can be coupled to a top stiff plate 242 to create a first generally self-supporting structure. In another embodiment, a plurality of bottom isolators 236 can be coupled to a bottom stiff plate 246 to create a second generally self-supporting structure, wherein the second generally self-supporting structure can be coupled to the first generally self-supporting structure. In yet another embodiment, a plurality of intermediate isolators can be coupled to an intermediate stiff plate to create a third generally self-supporting structure, wherein the third generally self-supporting structure can be coupled to the first generally self-supporting structure and/or the second generally self-supporting structure, including between the first generally self-supporting structure and the second generally self-supporting structure.

The motor mount assembly 220 may further comprise an optional weight 248. The weight 248 may help keep the motor mount assembly 220 stable and less likely to shake or vibrate.

The noise dampening system 250, described in greater detail below, can generally comprise a shroud 252, inlet acoustic foam 254, and outlet acoustic foam 256. The shroud 252, and foam 254, 256 preferably act as sound barriers and absorbers, respectively. Acoustic foam 254 is shown as present on one side of the housing 270, but may be present additional or all sides.

In one embodiment, the ventilation system 260 can generally comprise a fan 262, an inlet cover 264, and an outlet cover 266. The inlet cover 264 and the outlet cover 266 can be received in and used to cover openings or air vents (not illustrated) in the housing 270 of the motorized base. Such openings or air vents in the housing 270 can be formed or machined as desired. The inlet cover 264 and/or the outlet cover 266 may include minimal and/or small openings to aid in the ventilation of the blender 100 and/or the motorized base 200, while also decreasing, or preventing, sound from escaping from the blender 100, motorized base 200, and/or the housing 270.

In one embodiment, the housing 270 can be provided without any openings or only a few minimal, small openings to reduce or prevent any sound from escaping from the housing 270. Further, the housing 270 can generally comprise a front side, a back side, a left side, and a right side. The housing 270 can comprise dense, thick, and/or stiff material, including plastic or other suitable materials, or any combination thereof, that provides large sound transmission loss for purposes of muffling or suppressing the sound produced by the electric motor 212 or other components of the blender 100.

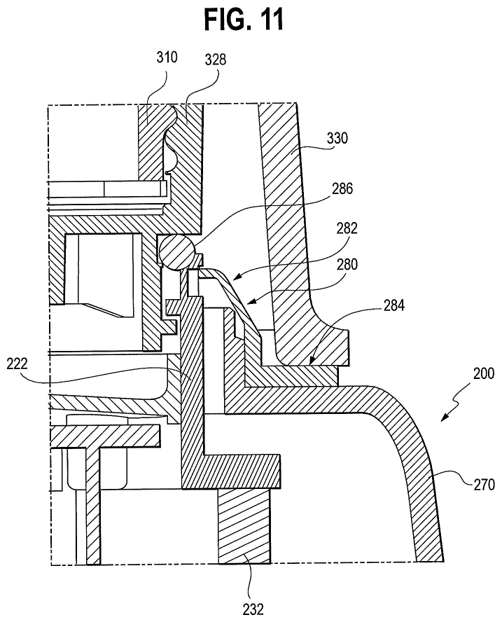

The sealing sub-assembly 280 can comprise a liquid gasket and a sound gasket (illustrated and described for FIG. 11). The sealing sub-assembly 280 can further comprise a sealing ring 286 adapted to fit between the motor mount 222 and a jarnut (described below) when the two are operably coupled together.

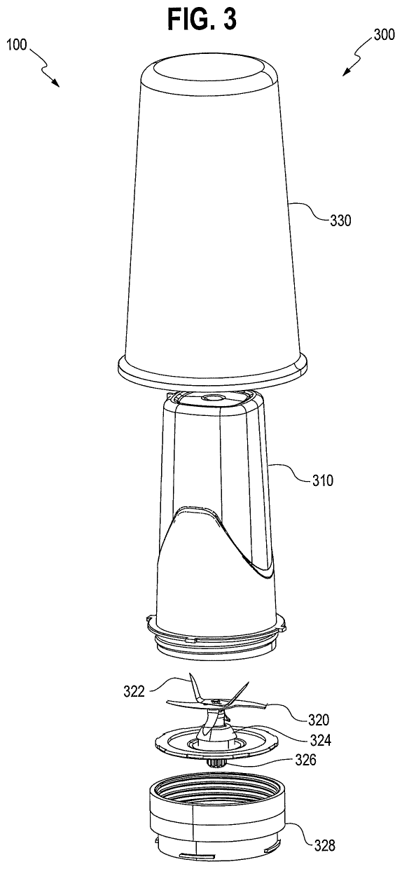

As illustrated in FIG. 3, the mixing assembly 300 can generally comprise a blending container 310, a blade sub-assembly 320, and a sound cover 330. The blade sub-assembly 320 can generally comprise at least one blade 322, a blade shaft 324, a blade shaft coupler 326, and a jarnut 328. In one embodiment, when the blade sub-assembly 320 is operably coupled with the blending container 310, the at least one blade 312 can be entirely enclosed by and generally inside of the blending container 310.

In one embodiment, the sound cover 330 can be provided without any openings or only a few minimal, small openings to reduce or prevent any sound from escaping from the sound cover 330. Further, the sound cover 330 can comprise dense, thick, and/or stiff material, including plastic or other suitable materials, or any combination thereof, that provide large sound transmission loss for purposes of muffling or suppressing the sound produced by blending container 310 during use or other components of the blender 100.

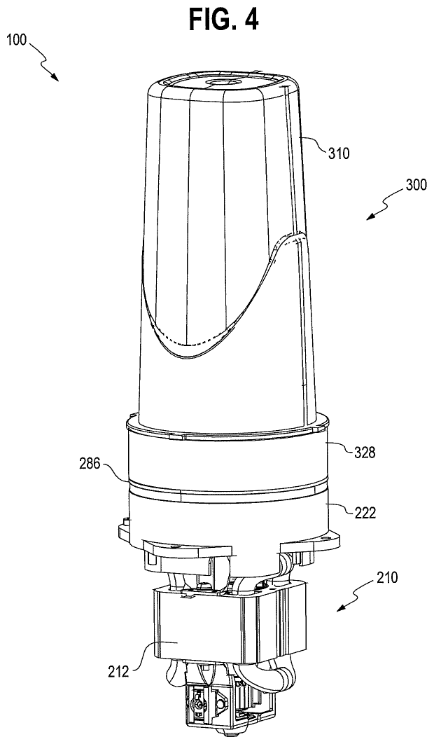

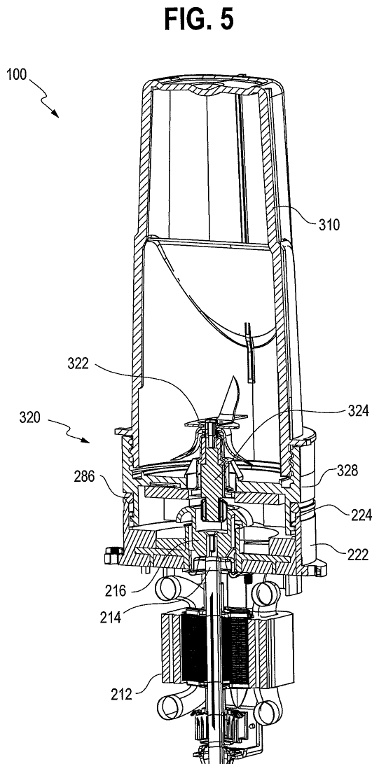

As provided in FIGS. 4 and 5, the motor assembly 210 can be operably coupled to the mixing assembly 300 via the motor mount 222. In one embodiment, after the blending container 310 is loaded with food or other substances to be blended, the blending container 310 and the at least one blade 322 can be locked to the motor mount assembly 220 by the user via the locking mechanism 224 of the motor mount 222. In another embodiment, the mixing assembly 300 can be operably coupled to the motor mount via jarnut 328. In yet another embodiment, the electric motor 212, the motor mount 222, the at least one blade 322, the jarnut 328, and the blending container 310 can be operably coupled to each other and generally comprise a vibrating assembly. The vibrating assembly can be structurally separated, isolated, and decoupled from the housing 270 and/or the sound cover 330, which can limit the amount of vibrations transmitted from the electric motor 212 to the housing 270 and/or the sound cover 330 that might otherwise cause the housing 270 and/or the sound cover 330 to vibrate and produce related noise, including through resonation. In another embodiment, when the jarnut 328 is operably coupled with the motor mount 222, the sealing ring 286 of the sealing sub-assembly 280 can be provided to maintain a gap or distance between the motor mount 222 and the jarnut 328 to prevent or dampen any vibrations that might be transmitted therebetween.

When locking the blending container 310 and the at least one blade 322 to the motor mount assembly 220 via the locking mechanism 224 of the motor mount 222, the self-centering coupling 216 can be operably coupled to the blade sub-assembly 320. The self-centering coupling 216 can transmit torque from the electric motor 212 to the at least one blade 322 located inside blending container 310 for blending. In one embodiment, the self-centering coupling 216 can comprise a long-taper coupling, and the locking mechanism 224 of the motor mount 222 can use a semi-threaded locking feature. That way, the motor shaft 214 and blade shaft 324 have minimal, or little, parallel, angular, and general misalignment.

Further, in another embodiment, the jarnut 328 can secure directly to the motor mount 222 and further provide improved alignment for the blender 100. Reducing parallel, angular, and general misalignment between the motor shaft 214 and the blade shaft 324 can have the desirable result of further reducing the harmonic vibration resulting from looseness, unbalance, high tolerances, and misalignment between the electric motor 212 and the mixing assembly 300, including the blending container 310 and the at least one blade 322. Other blenders are designed so that the blending jar loosely sits on top of the blender housing, or where the electric motor connects directly to the housing, making it resonate during operation.

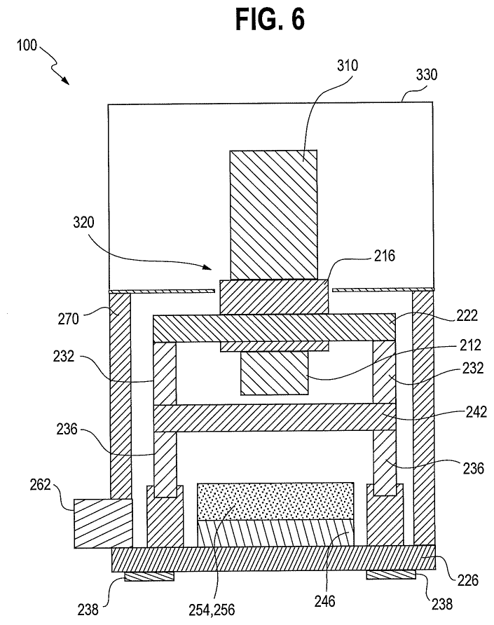

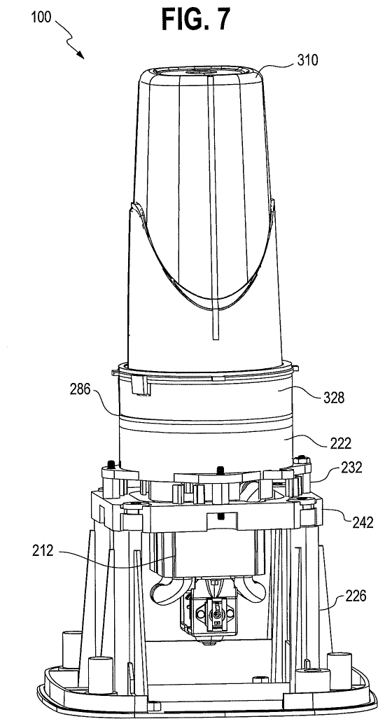

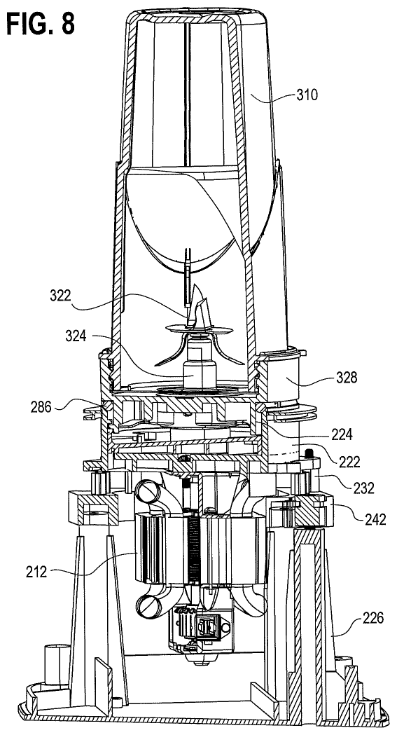

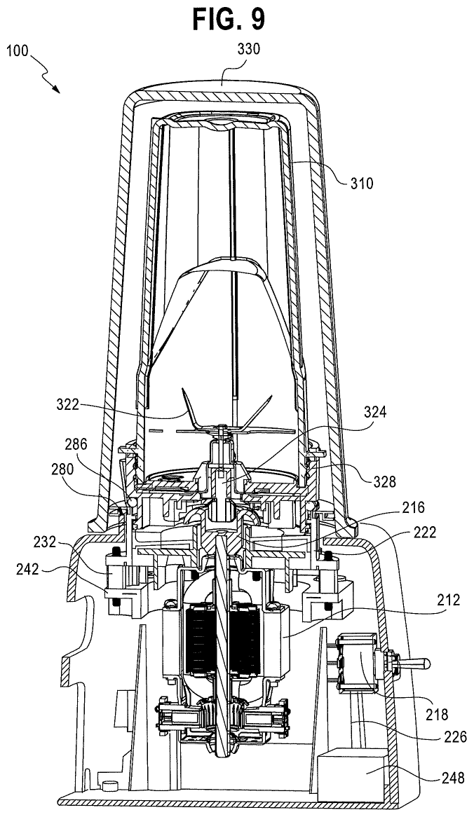

Turning to FIGS. 6-9, the electric motor 212 can be attached to or otherwise operably coupled with the motor mount 222. In one embodiment, the motor mount 222 can be attached one of the stiff plates 240, including the top stiff plate 242. However, it will be understood that the motor mount 222 can be attached to any one of the stiff plates 240, including, without limitation, the intermediate stiff plate (not illustrated), and/or the bottom stiff plate 246. Further, it will be understood that the motor mount 222 can be attached to any other component of the motor mount assembly 220, including, without limitation, any of the isolators 232, 236. In one embodiment, the motor mount 222 can be adapted to support the electric motor 212 independently from any other structural element of the motor mount assembly 220, including, without limitation, the isolators and/or the stiff plates.

As best exemplified in FIG. 6, in one embodiment, the motor mount 222 can be attached to the top stiff plate 242 via the top isolators 232, such that high frequency vibration produced by the blending agitation of the blender 100 can be absorbed by the motor mount assembly 220, including through the top stiff plate 242 and the top isolators 232. The dual-dampening effect of using at least one of the isolators with at least one of the stiff plates can provide the desired effect of isolating the base 226 from the vibrations produced by the electric motor 212 or other components of the blender 100. In another embodiment, the top stiff plate 242 can be coupled to an additional one of the stiff plates, including, without limitation, the intermediate stiff plate (not illustrated) or the bottom stiff plate 246 through additional ones of the isolators, including without limitation, the intermediate isolators (not illustrated) and the bottom isolators 236.

Coupling the motor mount 222 to additional the isolators and/or the stiff plates can have the desired effect of absorbing additional vibrations produced by the blending agitation of the blender 100. In one embodiment, the bottom isolators 236 can couple the motor mount 222 to the base 226 of the motor mount assembly 220, including via any combination of the stiff plates and isolators attached thereto. Further, the base 226 of the motor mount assembly 220 can then be in contact with a surface, such as a kitchen countertop, via the feet 228. In another embodiment, the base 226 of the motor mount 222 can be can coupled with the feet 228 via the feet isolators 238. In such embodiments, where the motor mount 222 is coupled directly or indirectly to a surface external of the blender 100, including a kitchen countertop, though any combination of the base 226, the isolators 230, and the stiff plates 240, this can have the desired effect of absorbing lower frequency vibration produced by the blending agitation of the blender 100, which typically require a higher total mass to dampen. In one embodiment, coupling the motor mount 222 directly or indirectly to a surface, including a kitchen countertop, can have the effect producing a vibration transmissibility reduction of 1:20 from motor mount 222 to the base 226.

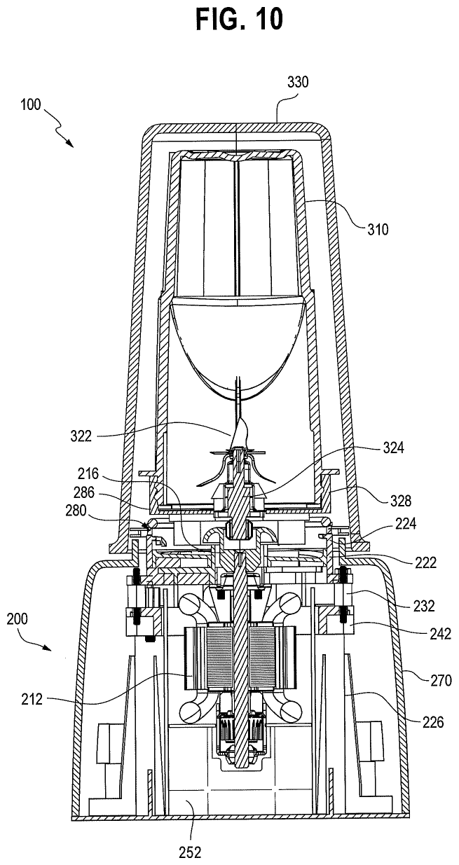

As most clearly illustrated in FIGS. 10 and 11, in one embodiment, the housing 270 can be attached or otherwise connected to the motorized base 200. The housing is preferably attached or connected to the motorized base 200 in a way that it does not receive vibrations or produce noticeable noise, including through resonation, from the blending agitation of the blender 100, including the vibration of the electric motor 212, the self-centering coupling 216, the motor mount 222, or the blending container 310. In one embodiment, the housing 270 is attached or connected to the base 226 of the motorized base 200, including at a point that is physically separated or away from the source of any noise or vibration of the motorized base, including, without limitation, the electric motor 212. In such an embodiment, the housing 270 is not directly coupled to the electric motor 212, the self-centering coupling 216, the motor mount 222, or the blending container 310. Providing structural separation between the electric motor 212, the self-centering coupling 216, the motor mount 222, and the blending container 310 and the housing 270 can have the effect of decoupling or isolating the housing 270 from the electric motor 212. This may limit the amount of vibrations transmitted from the electric motor 212 to the housing 270 that could cause the housing 270 to vibrate or resonate.

Further, isolating the sound cover 330 from the source of any vibration can reduce the likelihood of it vibrating or resonating. In another embodiment, this can be further achieved through the use of a system of the isolators and/or stiff plates that couple both the electric motor 212 and the housing 270 to the motorized base 200, while also providing structural separation between the electric motor 212 and the housing 270, which can have the effect producing various vibration transmissibility reductions, as explained herein.

In one embodiment, when the motorized base 200 is operably coupled to the mixing assembly 300, including by operably coupling the motor assembly 210 to the mixing assembly 300 via the motor mount 222, a sound cover 330 can be placed over the blending container 310 and blade sub-assembly 320 of the mixing assembly 300. The sound cover 330 can be sealingly attached or mounted to the housing 270 to seal in and to prevent the direct transmission of sound from the surface of the blending container 310, which may be due to liquid cavitation, ice crushing, and the like, to the user. In such an embodiment, since the sound cover 330 is only directly attached to the housing 270 of the motorized base 200, it can be similarly structurally separated, isolated, and decoupled from the electric motor 212, which can limit the amount of vibrations transmitted from the electric motor 212 to the sound cover 330 that might otherwise cause the sound cover 330 to vibrate and produce related noise, including through resonation. Further, isolating the sound cover 330 from the source of any vibration can reduce or prevent it from vibrating or resonating.

In another embodiment (see FIG. 11), the housing 270 can further include a sealing sub-assembly 280 located on a top surface of the housing 270. The sealing sub-assembly 280 can comprise a liquid gasket 282 and a sound gasket 284, and can create a seal between the top of the housing 270 and the sound cover 330 when the sound cover 330 is attached to or operably coupled with the housing 270. In another embodiment, where the sealing ring 286 of the sealing sub-assembly 280 is provided to maintain a gap or distance between components of the motorized base 200 and the mixing assembly 300, including the motor mount 222 and the jarnut 328, to prevent or dampen the transmission of any vibrations, the liquid gasket 282 and/or the sound gasket 284 can comprise flaps for covering the gap, distance, and/or the sealing ring 286.

The seal created by the sealing sub-assembly 280 can, among other things, prevent liquids from reaching the electric motor 212 and limit the amount of sound that can escape from the sound cover 330. Specifically, the liquid gasket 282 can comprise a thin liquid seal that seals liquids away from the electric motor 212 without transmitting vibration from the electric motor 212, the self-centering coupling 216, the motor mount 222, or the blending container 310. The sound gasket 284 can comprise a thin seal that seals the sound cover 330 to the top of the housing 270 to limit the amount of sound that can escape from the sound cover 330 without transmitting vibration from the electric motor 212, the self-centering coupling 216, the motor mount 222, or the blending container 310. In this way, the sound cover 330 can sealingly engage with the housing 270 to create an external structure of the blender 100 to which the vibration from the electric motor 212, the self-centering coupling 216, the motor mount 222, or the blending container 310 are not transmitted.

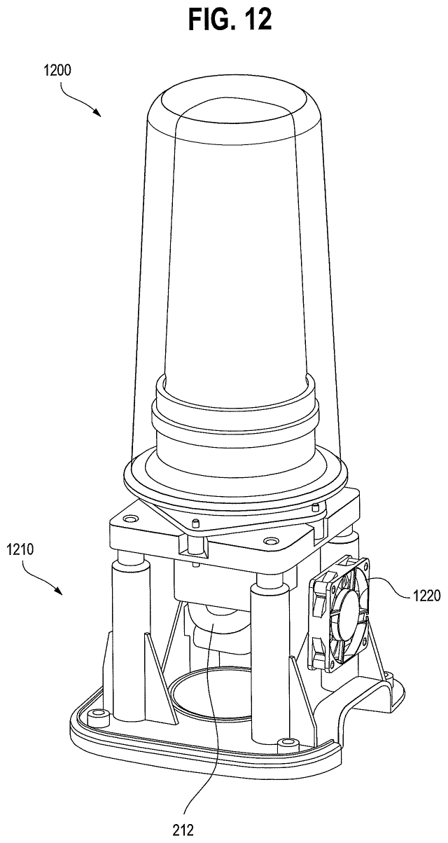

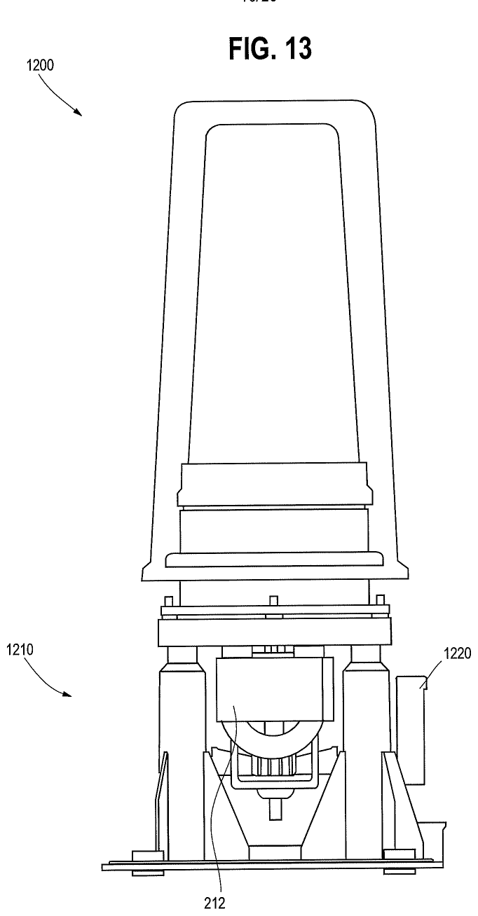

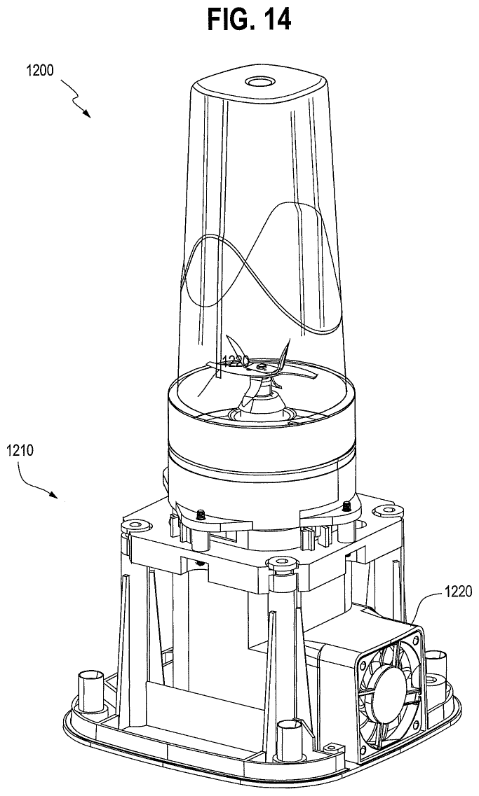

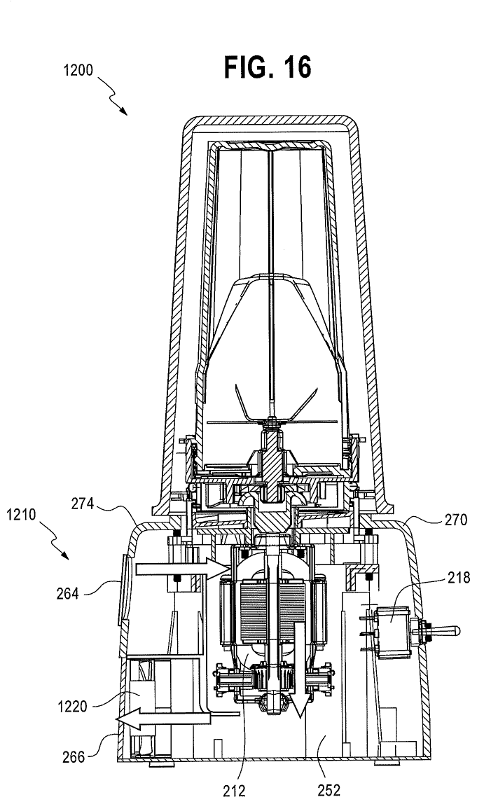

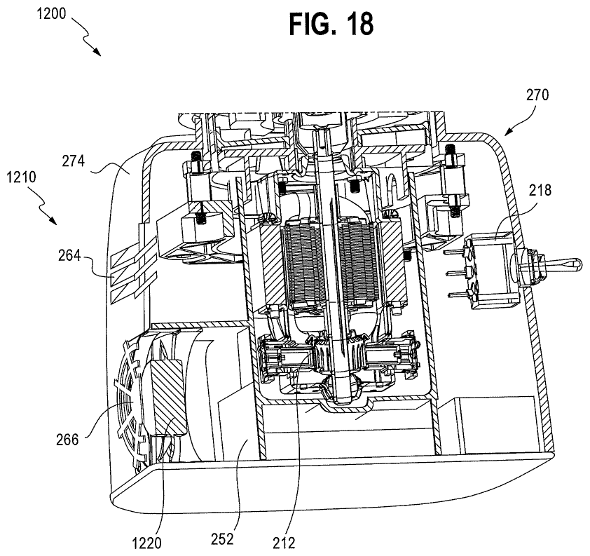

As best illustrated in FIGS. 12-18, in one embodiment, an alternatively constructed blender 1200 can comprise a ventilation system 1210 that includes a decoupled fan 1220. An independently controlled low-speed, low-noise (e.g., a fan that does not produce a noise exceeding 67 dBA, or a fan that is 3 dB quieter than the target sound of the blender) decoupled fan 1220 can be provided in cases where the blender 1200 may utilize a high-power electric motor such as the electric motor 212, that can achieve, for example, approximately 15,000-20,000 revolutions per minute. By decoupling the decoupled fan 1220 from the high-power electric motor 212, the speed of the decoupled fan 1220 can be controlled independently of the speed of the high-power electric motor 212 to create improved airflow within the motorized base 200 independent of the function of the electric motor 212. As will be understood, an axial fan, a cross flow fan, a centrifugal fan, a turbine fan, or any other type of fan may be used. Further, the fan 1220 may or may not be attached to the motor shaft 212.

Further, when the decoupled fan 1220 is independently activated from the electric motor 212, the decoupled fan 1220 can be started by the signal from a microprocessor (not shown) or a temperature sensor (not shown) coupled with the decoupled fan 1220, so that the decoupled fan 1220 is only used when needed. In one embodiment, the decoupled fan 1220 can comprise a brushless direct current motor. However, it will be understood that the decoupled fan 1220 can comprise any suitable motor, whether presently known or later developed. Other blenders that are designed to integrate the fan with the high-power electric motor, including through integration with a motor shaft driven by the electric motor, are susceptible to high noise associated with the high revolution rate of the fan driven by the high-power electronics, among other things associated with such a blender.

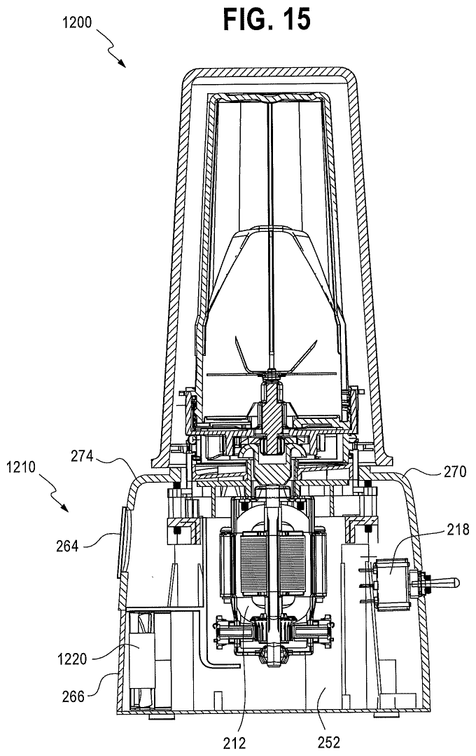

As provided in FIGS. 15-18, the ventilation system 1210 can further comprise an inlet cover 264 and an outlet cover 266. The inlet cover 264 and the outlet cover 266 depicted in FIGS. 15-18 are both shown as residing on a back side 274 of the housing 270. In this way, the inlet cover 264 and the outlet cover 266, and the respective air vents, can be located away from the user, who will be generally facing the power switch 218. However, it will be understood that the inlet cover 264 and the outlet cover 266 of the blender 1200 can reside on any of the sides or surfaces of the housing 270. Further, as provided in FIGS. 15-18, in one embodiment, the inlet cover 264 can be located generally above the outlet cover 266 on the housing 270. However, it will be understood that the inlet cover 264 and the outlet cover 266 of the blender 1200 can be oriented in any suitable manner on the housing 270.

In one embodiment, the inlet cover 264 and/or the outlet cover 266 can comprise louver vents that selectively open and close depending on the differential pressure forces provided within the housing 270. The decoupled fan 1220 can create the differential pressure forces to selectively open the louver vents of the inlet cover 264 and/or the outlet cover 266 during operation of the blender 1200, as necessary for ventilation purposes. When the louver vents are closed, the inlet cover 264 and/or the outlet cover 266 can interrupt the escape path of the sound produced by the electric motor 212 to suppress the same.

In another embodiment, the inlet cover 264 and/or the outlet cover 266 can comprise a mechanically actuated gate. The mechanically actuated gates of the inlet cover 264 and/or the outlet cover 266 can be selectively and remotely actuated to open during operation of the blender 1200, as necessary for ventilation purposes. When the mechanically actuated gates are closed, the inlet cover 264 and/or the outlet cover 266 can interrupt the escape path of the sound produced by the electric motor 212 to suppress the same.

In yet another embodiment, the inlet cover 264 and the outlet cover 266, and the respective air vents, can be situated in a manner such that there is no direct line of sight between the electric motor 212 and the outside of the blender 1200 or the housing 270, to reduce or prevent any sound from escaping from the housing 270 through the inlet cover 264 and the outlet cover 266, and the respective air vents. This creates a torturous airflow path for the ventilation system 260, which can muffle the sound produced by the electric motor 212. This can be achieved through the design of the shroud 252 surrounding the electric motor 212, which can disrupt straight line flow paths between the electric motor 212 and the inlet cover 264 and the outlet cover 266, and the respective air vents. In this way, sound generated by the electric motor 212 may encounter and bounce on at least the plastic walls of the shroud 252 and/or the housing 270.

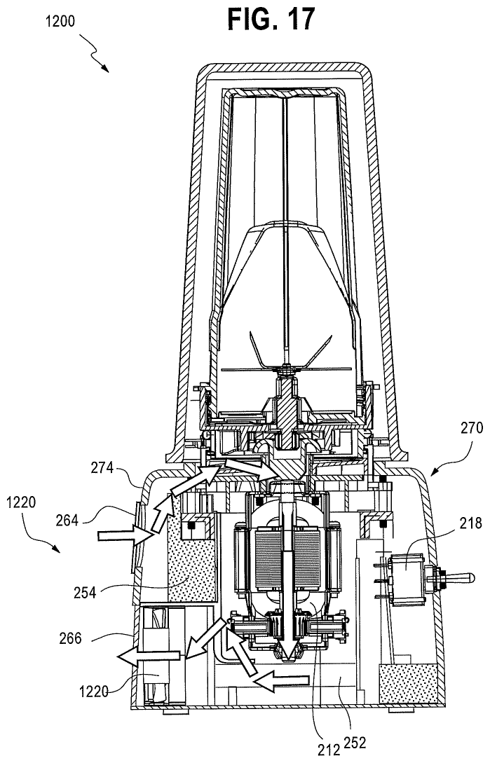

In one embodiment, reverberating sound within the housing 270 of motorized base 200 produced by the electric motor 212 can be dampened or absorbed through the use of the noise dampening system 250, including inlet acoustic foam 254 and/or the outlet acoustic foam 256. The inlet acoustic foam 254 and/or the outlet acoustic foam 256 can be placed near to the inlet cover 264 and the outlet cover 266, and the respective air vents, to reduce or prevent any sound from escaping from the housing 270 through the inlet cover 264 and the outlet cover 266, and the respective air vents. In this way, the sound produced by the electric motor 212 may encounter and bounce on at least the sound-absorbing inlet acoustic foam 254 and/or the outlet acoustic foam 256. As embodied by FIG. 17, when used in combination with the shroud 252, as discussed herein, the sound produced by the electric motor 212 may encounter and bounce on at least the sound-absorbing inlet acoustic foam 254 and/or the outlet acoustic foam 256 as well as the plastic walls of the shroud 252 and/or the housing 270 to further reduce or even prevent any sound from escaping from the housing 270 through the inlet cover 264 and the outlet cover 266, and the respective air vents. Wall thicknesses of some or all components, including but not limited to those made of plastic, may also be increased by approximately 30%. Components which may previously have had thicknesses of 2-3 mm may be increased to 4 mm, as a non-limiting example.

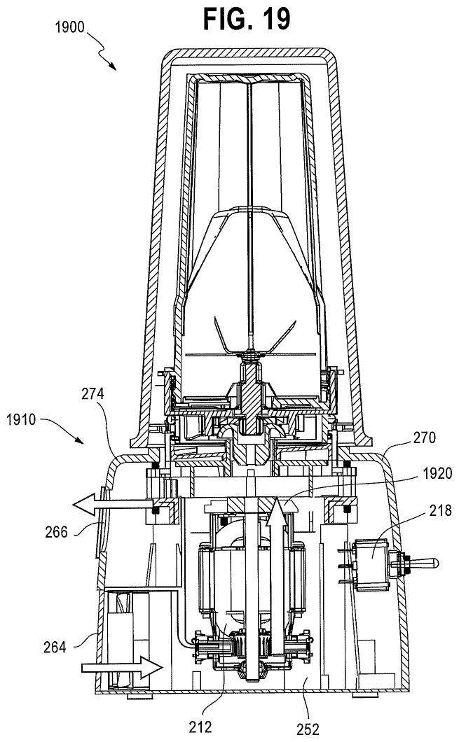

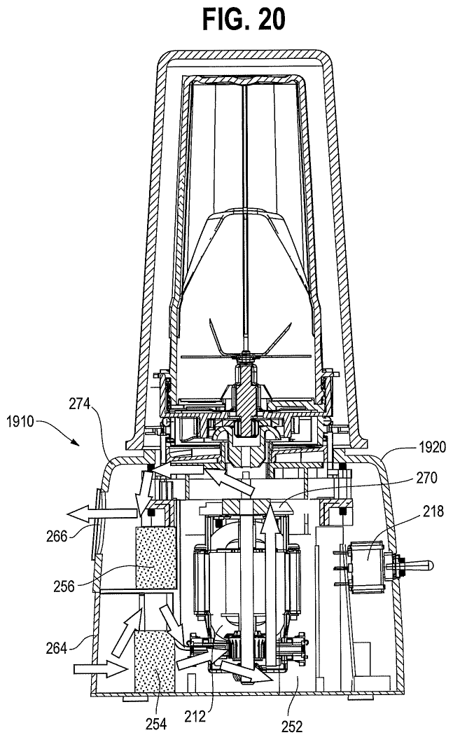

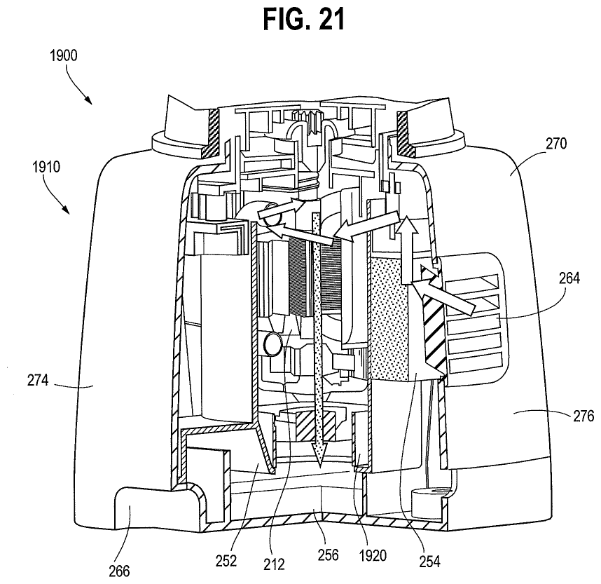

As illustrated in FIGS. 19-21, in one alternative embodiment, blender 1900 can comprise a ventilation system 1910 that includes an integrated fan 1920. An integrated fan 1920 can be provided in cases where the blender 1900 may utilize a low-power or speed-blending electric motor 212, including an electric motor 212 that can achieve approximately 10,500 revolutions per minute. The integrated fan 1920 can be attached to the motor shaft 214 between the motor mount 222 and a motor bracket (not shown) supporting the electric motor 212. In another embodiment, as shown in FIG. 21, the integrated fan 1920 can be located below the electric motor 212 or generally distal of the top of the motorized base 200. Coupling the integrated fan 1920 with the electric motor 212 located generally at the center of the housing 270 has the advantage of moving the integrated fan 1920 and the sounds that it produced, including any sounds that may be produced from any high noise associated with a high revolution rate of the integrated fan 1920, further away from the inlet cover 264 and the outlet cover 266, and the respective air vents. Further, by coupling the integrated fan 1920 with the electric motor 212, the overall size of the housing 270 and the blender 1900 can be reduced.

The ventilation system 1910 can further comprise an inlet cover 264 and an outlet cover 266. The inlet cover 264 and the outlet cover 266 depicted in FIGS. 19-21 are shown as both positioned and located on the back side 274 of the housing 270. In this way, the inlet cover 264 and the outlet cover 266, and the respective air vents, can be located away from the user, who will be generally facing the power switch 218. However, it will be understood that the inlet cover 264 and the outlet cover 266 of the blender 1900 can reside on any of the sides or surfaces of the housing 270. Further, in one embodiment, the inlet cover 264 can be located generally below the outlet cover 266 on the housing 270. However, it will be understood that the inlet cover 264 and the outlet cover 266 of the blender 1200 can be oriented in any suitable manner on the housing 270. Further, alternate airflow directions are possible.

Further, in another embodiment shown in FIG. 21, the inlet cover 264 and the outlet cover 266 can reside on different sides of the housing 270, such as the back side 274 and a left side 276. In this way, the inlet cover 264 and the outlet cover 266, and the respective air vents, can be located away from the user. At the same time, any sound that might escape the inlet cover 264 and/or the outlet cover 266 can be dispersed in diverging directions to further reduce the effect of the noise in any one direction relative to the housing 270. However, it will be understood that the orientation of the inlet cover 264 and the outlet cover 266 on the blender 1900 can also apply to the other blenders 100, 1200 discussed herein or otherwise contemplated by this disclosure.

In one embodiment, the inlet cover 264 and/or the outlet cover 266 can comprise louver vents that selectively open and close depending on the differential pressure forces provided within the housing 270. The integrated fan 1920 can create the differential pressure forces to selectively open the louver vents of the inlet cover 264 and/or the outlet cover 266 during operation of the blender 1900, as necessary for ventilation purposes. When the louver vents are closed, the inlet cover 264 and/or the outlet cover 266 can interrupt the escape path of the sound produced by the electric motor 212 to suppress the same.

In another embodiment, the inlet cover 264 and/or the outlet cover 266 can comprise a mechanically actuated gate. The mechanically actuated gates of the inlet cover 264 and/or the outlet cover 266 can be selectively and remotely actuated to open during operation of the blender 1900, as necessary for ventilation purposes. When the mechanically actuated gates are closed, the inlet cover 264 and/or the outlet cover 266 can interrupt the escape path of the sound produced by the electric motor 212 to suppress the same.

In yet another embodiment, the inlet cover 264 and the outlet cover 266, and the respective air vents, can be situated in a manner such that there is no direct line of sight between the electric motor 212 and the outside of the blender 1900 or the housing 270, to reduce or prevent any sound from escaping from the housing 270 through the inlet cover 264 and the outlet cover 266, and the respective air vents. This creates a torturous airflow path for the ventilation system 260, which can muffle the sound produced by the electric motor 212. This can be achieved through the design of the shroud 252 surrounding the electric motor 212, which can disrupt straight line flow path between the electric motor 212 and the inlet cover 264 and the outlet cover 266, and the respective air vents. In this way, the sound produced by the electric motor 212 may encounter and bounce on at least the plastic walls of the shroud 252 and/or the housing 270.

In one embodiment, reverberating sound within the housing 270 of motorized base 200 produced by the electric motor 212 can be dampened or absorbed through the use of the noise dampening system 250, including inlet acoustic foam 254 and/or the outlet acoustic foam 256. The inlet acoustic foam 254 and/or the outlet acoustic foam 256 can be placed relative to the inlet cover 264 and the outlet cover 266, and the respective air vents, to reduce or prevent any sound from escaping from the housing 270 through the inlet cover 264 and the outlet cover 266, and the respective air vents. In this way, the sound produced by the electric motor 212 must encounter and bounce on at least the sound-absorbing inlet acoustic foam 254 and/or the outlet acoustic foam 256. When used in combination with the shroud 252, as discussed herein, the sound produced by the electric motor 212 must encounter and bounce on at least the sound-absorbing inlet acoustic foam 254 and/or the outlet acoustic foam 256 as well as the plastic walls of the shroud 252 and/or the housing 270 to further reduce or even prevent any sound from escaping from the housing 270 through the inlet cover 264 and the outlet cover 266, and the respective air vents.

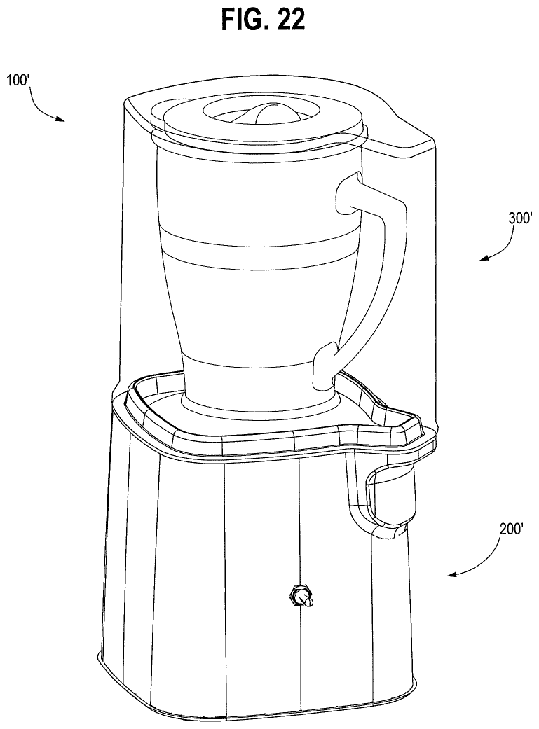

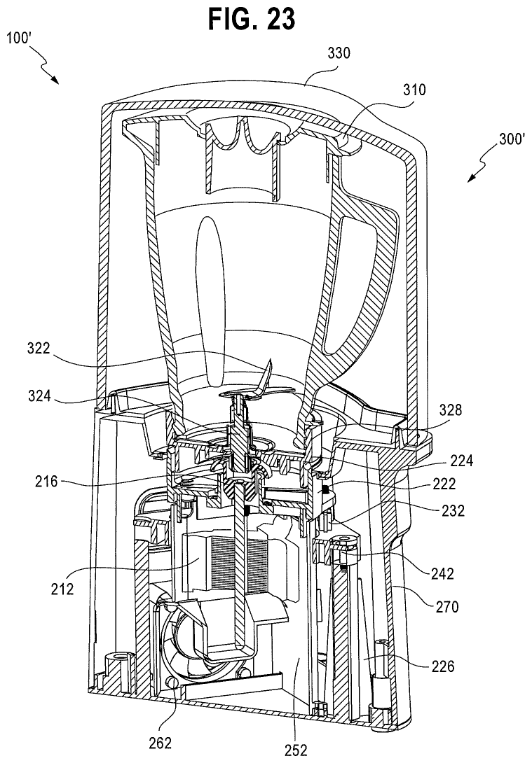

Turning to FIGS. 22 and 23, another embodiment of a blender 100′ subject of the current application may generally comprise a motorized base 200′ and a mixing assembly 300′. Such blender 100′ being similar to a blender 100, wherein such motorized base 200′ and mixing assembly 300′ being similar to, respectively, motorized base 200 and mixing assembly 300, and generally capable of providing larger serving portions (i.e., not single-serve or small servings).

From the foregoing, it will be seen that this invention is one well adapted to attain all the ends and objects hereinabove set forth together with other advantages which are obvious and which are inherent to the structure. It will be understood that certain features and sub combinations are of utility and may be employed without reference to other features and sub combinations. Since many possible embodiments of the invention may be made without departing from the scope thereof, it is also to be understood that all matters herein set forth or shown in the accompanying drawings are to be interpreted as illustrative and not limiting.

The constructions described above and illustrated in the drawings are presented by way of example only and are not intended to limit the concepts and principles of the present invention. Thus, there has been shown and described several embodiments of a novel invention. As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required.” Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention.

What is claimed is:

1. A sound-reducing system for reducing noise emitted by a motor in a blender, the sound-reducing system including:
a top stiff plate;
one or more top isolators coupled to the top stiff plate to form a first self-supporting structure;
a bottom stiff plate; and
one or more top isolators coupled to the bottom stiff plate to form a second self-supporting structure.

2. The sound-reducing system of claim 1 wherein the sound-reducing system is located within a base of the blender.

3. The sound reducing system of claim 2 wherein the base is coupled to a blending container in which contents to be blended are contained.

4. The sound reducing system of claim 1 further comprising foam abutting at least one of the top stiff plate, the one or more top isolators, the bottom stiff plate, and the one or more bottom isolators.

5. The sound reducing system of claim 3 further comprising a sound cover surrounding the blending container.

6. A blender system, the blender system comprising:
a motorized base including a motor within the motorized base;
at least one stiff plate located within the motorized base; and
at least one elastic isolator coupled to the stiff plate.

7. The blender system of claim 6 further including a mixing assembly coupled to the motorized base in which contents to be blended may be contained.

8. The blender system of claim 7, wherein the blender system includes a blending container and a sound cover surrounding the blending container.

9. The blender system of claim 6, wherein the blender system includes each of an upper stiff plate and a lower stiff plate, and wherein the at least one elastic isolator is coupled at a first end to the upper stiff plate and at a second end to the lower stiff plate.

10. The blender system of claim 6, wherein the motorized base further includes acoustic foam adjacent to the motor.

11. The blender system of claim 6, wherein the motorized base includes a fan decoupled from the motor for cooling the motor.

12. The blender system of claim 7 further comprising a sealing sub-assembly positioned and located between the motorized base and the mixing assembly such that the sealing sub-assembly physically abuts each of the motorized base and the mixing assembly.

13. The blender system of claim 6, wherein the blender system includes a housing surrounding the motor to further reduce noise emitted by the motor.

14. The blender system of claim 6 further comprising a shroud surrounding the motor that includes a tortuous internal path.

15. A blender system, the blender system comprising:
a motorized base including a motor within the motorized base; and
at least one isolator within the motorized base coupled to one or more components within the motorized base, the at least one isolator being elastic for reducing transmission of vibrations within the motorized base.

16. The blender system of claim 15, the motorized base further including at least one stiff plate contained therein for reducing transmission of vibrations within the motorized base.

17. The blender system of claim 15 further including a mixing assembly coupled to the motorized base in which contents to be blended may be contained.

18. The blender system of claim 17, wherein the blender system includes a blending container that can be coupled to the motorized base.

19. The blender system of claim 18, wherein the blender system includes a sound cover surrounding the blending container.

20. The blender system of claim 17 further comprising a sealing sub-assembly positioned adjacent to and abutting the motorized base for providing a gap between the motorized base and the blending container.
